(19) United States
(12) Patent Application Publication
(10) Pub. No.: US 2005/0277090 A1
(43) Pub. Date: Dec. 15, 2005

(54) Tooth implant arrangement

(76) Inventors: Matts Anderson, Lerum (SE); Izidor Brajnovic, Goteborg (SE); Ulf Johansson, Onsala (SE)

Correspondence Address: KNOBBE MARTENS OLSON & BEAR LLP, 2040 MAIN STREET, FOURTEENTH FLOOR, IRVINE, CA, 92614, US

(21) Appl. No.: 11/140,532

(22) Filed: May 27, 2005

(30) Foreign Application Priority Data
Nov. 28, 2002 (SE) NO.: SE 0203507-9
Nov. 20, 2003 (WO) PCT/SE03/01798

(51) Int. Cl. A61C 8/00

(52) U.S. Cl. 433/173; 433/174

(57) ABSTRACT

A tooth implant is used to replace a front tooth which has been lost or extracted. The implant comprises an anchoring part which is provided with an outer thread and which is applied in a recess formed in the jaw bone at the site of the lost or extracted tooth, a spacer sleeve part intended to extend through the gum of the jaw bone, and a prepared or preparable part which adjoins the spacer sleeve part and is intended to support a dental crown, for example. The anchoring part, the spacer sleeve part and the prepared or preparable part are arranged in one piece, the configuration and direction of the prepared or preparable part being substantially adapted or adaptable to the anatomy of the lost or extracted tooth, for example to the inner arc-shaped surface, and to the direction of said tooth. The one-piece implant affords a rapid and less traumatic replacement function compared to previously used three-part bridges.

### PRIORITY INFORMATION

This application is a continuation of International Application PCT/SE2003/001798, with an international filing date of Nov. 20, 2003, published in English and which claims priority under 35 U.S.C. § 119 to Swedish Patent Application No. SE 0203507-9, filed Nov. 28, 2002, the entire contents of both of which are expressly incorporated by reference herein.

### BACKGROUND OF THE INVENTION

1. Field of the Invention

The present invention relates to a tooth implant arrangement for replacing a front tooth which has been lost or extracted.

2. Description of the Related Art

In cases where a front tooth has been lost or extracted, it is already known to replace the tooth with the aid of a bridge construction, which means that the adjacent tooth or teeth must be ground down to constitute an attachment for the bridge in question. Thus, for example, it has been possible to create a three-part bridge, which in this connection has been considered to provide a mechanically strong solution. In this connection, reference may be made in purely general terms to the use to which such three-part bridges are put in practice.

Loss of a front tooth can affect people of all ages, for example in connection with sports activities, as a result of road accidents, etc. Loss of a front tooth can feel very traumatic and may even restrict the person's social life since a tooth replacement of said conventional type generally takes a considerable time. In some circumstances it may even be desirable to voluntarily correct a defective or malpositioned tooth (tooth root) using a tooth replacement.

### SUMMARY OF THE INVENTION

Accordingly, there is a great need for effective alternatives to the known technique in connection with the loss or extraction of a front tooth. It is an object of an embodiment of the present invention to solve this problem and propose a tooth implant configured as a single piece for replacing a lost or extracted front tooth. There is a particular also need for the treatment to be able to be carried out relatively quickly and for the solution with the one-piece implant to constitute a totally satisfactory alternative from the point of view of stability. An object of an embodiment of the present invention is to also solve this problem.

Tooth status and tooth appearance may vary considerably and there is therefore a need to be able to offer an attractive replacement alternative which can be used in the majority of cases which occur. An object of an embodiment of the present invention is to also solve this problem.

Accordingly, an embodiment of the present invention relates to a tooth implant arrangement for replacing a front tooth which has been lost or extracted, in which the implant comprises an anchoring part, for example an anchoring part which is provided with an outer thread and which is applied in a recess formed in the jaw bone at the site of the lost or extracted tooth. The arrangement also comprises a spacer sleeve part intended to extend through the gum of the jaw bone, and a prepared or preparable part which adjoins the spacer sleeve part and is intended to support a tooth replacement, for example a dental crown.

Another embodiment of the present invention comprises where, inter alia, by integration of the anchoring part, the spacer sleeve part and the prepared or preparable part, the tooth implant constitutes a one-piece tooth implant in which the configuration and direction of the preparation part is substantially adapted or adaptable to the anatomy of the lost or extracted tooth, for example to the inner arc-shaped surface, and to the direction of said tooth.

Another embodiment of the present invention comprises a tooth implant for replacing a front tooth which has been lost or extracted. The implant includes an anchoring part that is configured to fit within a recess formed in the jaw bone at the site of the lost or extracted tooth. The implant also includes a spacer sleeve part configured to extend through the gum of the jaw bone. The implant further comprises a prepared or preparable part which adjoins the spacer sleeve part and is configured to support a tooth replacement. The anchoring part, the spacer sleeve part and the prepared or preparable part form an integral unit and the configuration and direction of the prepared or preparable part is substantially adapted or adaptable to the anatomy of the lost or extracted tooth.

Another embodiment of the present invention comprises a method of replacing a front tooth that comprises placing a template about a front tooth to be replaced, drilling a hole into a jawbone with the aid of the template, inserting a one piece implant comprising a anchor part, a sleeve part and a support part into the hole in the jawbone, and rotating the implant until the support part is in a proper position with respect to the adjacent anatomy.

Further embodiments will become clear from the attached dependent claims and from the description.

An advantage of an embodiment of the present invention is that it can be used to individually replace the front teeth, for example the six front-most teeth of the upper jaw and lower jaw. The one-piece implant is considered as implant, spacer and prepared part on which a dental crown, for example of porcelain, is cemented. The prepared part can be prefabricated or can be tailored to the specific customer if necessary. The porcelain crown can be prefabricated, i.e. adapted to the prefabricated prepared part. Said prepared part can be prefabricated at different angle directions and in different preparation shapes to correspond to the anatomy of the different teeth. The prepared part can include, in the axial direction, a tool socket so that the one-piece tooth implant can be mounted in place in the jaw bone. The length of the spacer part forming a passage through the skin can be varied depending on the requirements, for example depending on the thickness of the gum. To prevent the gray color of the metal showing through, the surface of the spacer part can be treated to give it a color more akin to the tooth root in order to acquire the natural appearance of the tooth root. This can alternatively be done by sputtering with a biocompatible material in the chosen tooth color, or by covering the spacer part with a ceramic sleeve of the desired thickness and shape. The one-piece implant can be fitted in place with the aid of a template in which a sleeve is used. The bone/jaw bone is drilled via the sleeve in a preplanned direction and to a predetermined depth. The drilling depth and drilling direction can be determined by X-ray or computed tomography.

For purposes of summarizing the invention, certain aspects, advantages and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

A presently proposed embodiment of an arrangement having the defining characteristics of the invention will be described below with reference to the attached figures, where

FIG. 1 shows, in a vertical view, a one-piece implant applied in a lower jaw, with the lower jaw extending substantially at right angles to the plane of the figure;

FIG. 2 shows a perspective view, from underneath and from in front, of a one-piece implant applied in the upper jaw as a replacement for a front tooth, with a template being used for drilling a hole in the jaw bone and for positioning the one-piece implant;

FIG. 3 shows a side view of an introductory stage of the application of the replacement according to FIG. 2 in which a hole has first been drilled with the aid of the template, and the one-piece implant has then been applied in the direction of the hole via a sleeve placed in the template; and

FIG. 4 shows a side view of the implant screwed into the hole and with a preparation part arranged in the implant in connection with the lost or extracted front tooth in question.

### DETAILED DESCRIPTION OF THE PREFERRED EMBODIMENTS

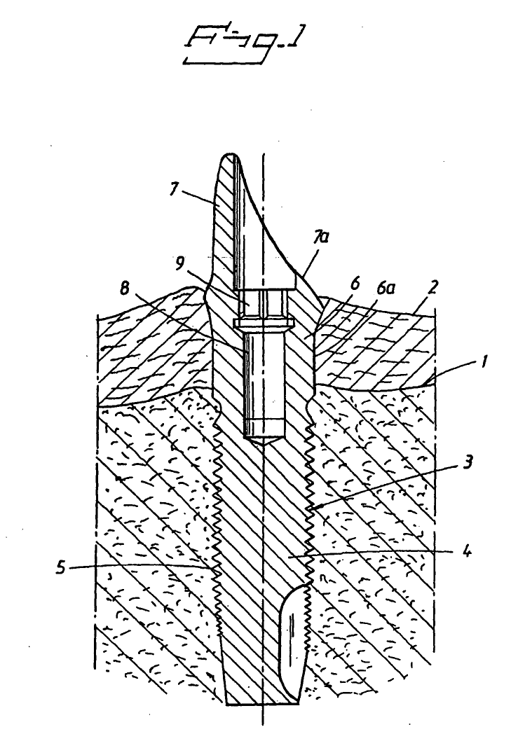

In FIG. 1, a jaw bone is designated by reference number 1, and the gum of the jaw bone is designated by reference number 2. The illustrated part of the jaw bone 1, which may be a lower jaw, extends substantially at right angles to the plane of the paper in FIG. 1. A one-piece implant 3 of the type in question is shown screwed securely into a drilled hole which has been formed in the jaw bone with a drill template and which may be threaded or unthreaded. The one-piece implant is designated overall by the reference number 3 and comprises, inter alia, an anchoring part 4 which is provided with an outer thread 5, via which the anchoring part can be screwed into the drilled hole. The anchoring part 4 merges into a spacer sleeve part or spacer sleeve portion 6 which is intended to extend through the gum 2. The spacer sleeve part 6 here has a height corresponding substantially to or slightly exceeding the thickness of the gum 2. Arranged on the spacer sleeve part 6 there is a prepared or preparable part 7 with an outer surface 7a directed toward the reverse face of the replacement dental crown, and said surface 7a is in this case arranged so that it adjoins said reverse face of the dental crown which extends in a concave shape. A dental crown (coated porcelain) with a concave inner surface is applied to the prepared part 7. Extending through the thus integrated parts 4, 6 and 7 there is a recess 8 provided with a tool socket 9 which can be acted on by a screwdriver of the star type, for example a tool socket and screwdriver of the type shown in WO 00/27300.

Said parts of the spacer sleeve 6 and/or preparation part 7 can be provided with a coating consisting of porcelain or other material which can be given a color corresponding to the color of the tooth root instead of showing the metal color of the part in question, which means that the transition or preparation line for the dental crown is not emphasized by having a color different than the color of the tooth root. An example of such a coating is shown in SE 8702445-1.

In an alternative embodiment, the part 6 in question can have its outside 6a sputtered with a biocompatible material in a manner known per se.

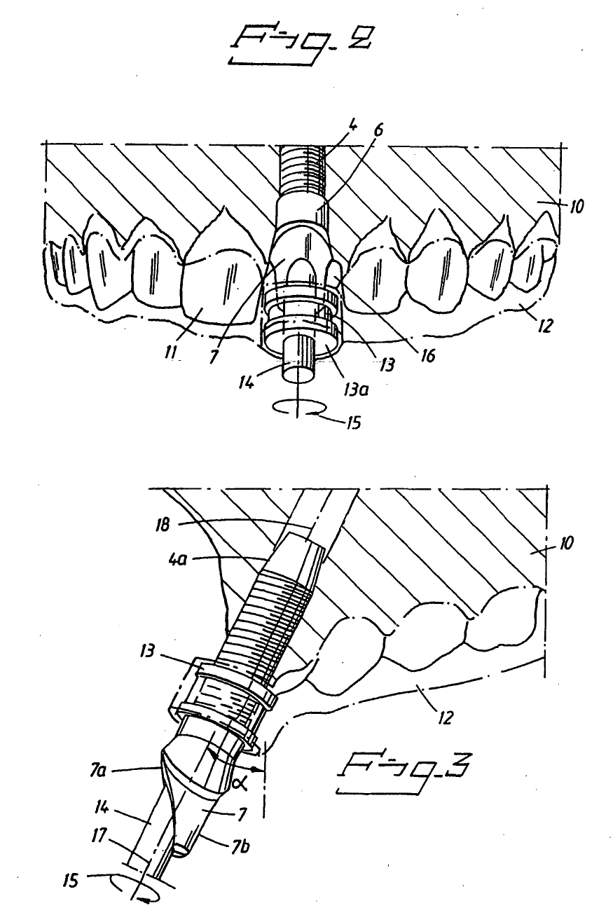

In FIG. 2, an upper jaw is designated by 10, and a front tooth by 11. The front tooth alongside the front tooth 11 has been lost and is to be replaced with a one-piece implant according to the invention. A hole is formed in the jaw bone using a drill (not shown in the figure) with which the hole in the jaw is made with the aid of a template 12. The template is provided with a guide sleeve 13 against whose inside surface 13athe drill can bear during formation of the hole. The template 12 can be designed in a manner known per se and has fastening members via which the template can be secured to the remaining teeth in the jaw bone in question. The template can have various shapes depending on the shapes of the remaining teeth, the shape of the jaw bone, etc. The sleeve 13 is also used for guiding the one-piece implant which is introduced with its tip (not shown in FIG. 2) from the outside via the inside of the sleeve. The implant is screwed into place with the aid of a screwing instrument 14 which is applied to the tool socket 9 according to FIG. 1. The implant is screwed in the clockwise direction 15 and is tightened so that the prepared part 7 can fit anatomically to the tooth in question which is to be replaced. The space for the dental crown is indicated by 16.

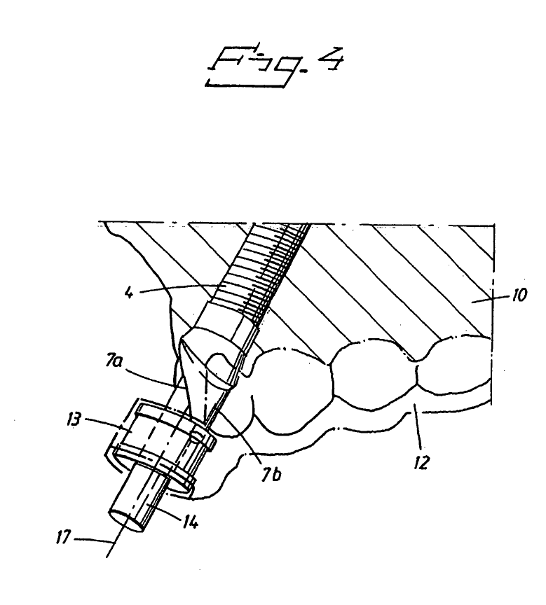

In FIG. 3, the one-piece implant is shown in a first position where it has been introduced into the sleeve 13 and the conical front part 4a of the anchoring part is introduced into the drilled hole. The design of the template 12 is shown here in a view different than FIG. 2. The direction of introduction is along the longitudinal axis 17 and coincides with the longitudinal axis 18 of the drilled hole. The direction 18 is chosen so that the anchoring takes place in a solid and well-preserved part of the jaw bone 10. To achieve optimal mechanical strength for the one-piece implant in the jaw bone, an angle a may vary. Said angle constitutes an angle between a vertical axis for the jaw bone and said directions of application for the hole 18 and the longitudinal axis 17. The optimum position of the drilled hole in question can be established in a manner known per se by X-ray examination. The rotation positions for the surfaces 7a and 7b on the prepared or preparable part are substantially associated with the case which is to form the replacement of the lost front tooth. The rotation position of the part 7 should be optimal so that the part 7 is accommodated fully in the dental crown or similar applied to the part. The dental crown is applied to the prepared part with the aid of cement or other binding substance or by securing members.

In FIG. 4, the one-piece implant has been given its final position in the jaw bone 10, and the action of the screwing function in the direction of rotation 15 (cf. FIG. 3) can stop. The anchoring part 14 has penetrated into the hole (cf. FIG. 3), and the prepared part 7 has been assigned a rotation position about the longitudinal axis 17 in which the surfaces 7a and 7b assume optimal positions from the point of view of closure. In this position, the template 12 can be withdrawn outward (downward) as can the screwing instrument.

The invention is not limited to the embodiment described above by way of example, and instead it can be modified within the scope of the attached patent claims and the inventive concept. Moreover, although the foregoing systems and methods have been described in terms of certain preferred embodiments, other embodiments will be apparent to those of ordinary skill in the art from the disclosure herein. Additionally, other combinations, omissions, substitutions and modifications will be apparent to the skilled artisan in view of the disclosure herein. While certain embodiments of the inventions have been described, these embodiments have been presented by way of example only, and are not intended to limit the scope of the inventions. Indeed, the novel methods and systems described herein may be embodied in a variety of other forms without departing from the spirit thereof.

1. A tooth implant for replacing a front tooth which has been lost or extracted, comprising:
an anchoring part that is configured to fit within a recess formed in the jaw bone at the site of the lost or extracted tooth;
a spacer sleeve part configured to extend through the gum of the jaw bone; and
a prepared or preparable part which adjoins the spacer sleeve part and is configured to support a tooth replacement, wherein the anchoring part, the spacer sleeve part and the prepared or preparable part form an integral unit and in which the configuration and direction of the prepared or preparable part is substantially adapted or adaptable to the anatomy of the lost or extracted tooth.

2. The implant as in claim 1, wherein the prepared or preparable part has an inner arc-shaped surface.

3. The implant as in claim 1, wherein the prepared or preparable part has an inner is adapted to the direction of said lost or extracted tooth.

4. The implant as in claim 1, wherein in the implant comprises a tool socket which includes means for screwing the implant into the recess formed in the jaw bone.

5. The implant as in claim 1, wherein the implant comprises a tool socket that includes a star-shaped grip function.

6. The implant as in claim 1, in combination with a dental crown.

7. The implant as in claim 1, in combination with a drill template which can be applied to the site of the recess for the lost or extracted tooth.

8. The implant as in claim 1, in combination with a tooth replacement part that is prefabricated for application on or to the prepared or preparable part.

9. The implant as in claim 1, wherein a length or height of the spacer sleeve part corresponds to the thickness of the gum.

10. The implant as in claim 1, wherein the spacer sleeve part has an outer surface comprising a biocompatible material of a chosen tooth color.

11. The implant as in claim 10, wherein the biocompatible material is applied by sputtering

12. The implant as in claim 1, wherein the spacer sleeve part is covered with an outer envelope of ceramic material having a chosen tooth color.

13. The implant as in claim 1, wherein the anchoring part is provided with an outer thread

14. The implant as in claim 1, wherein the prepared or preparable part is configured to receive a dental crown.

15. A method of replacing a front tooth, comprising:
placing a template about a front tooth to be replaced;
drilling a hole into a jawbone with the aid of the template;
inserting a one piece implant comprising a anchor part, a sleeve part and a support part into the hole in the jawbone; and
rotating the implant until the support part is in a proper position with respect to the adjacent anatomy.
